(19) United States
(12) Patent Application Publication
(10) Pub. No.: US 2024/0094535 A1
(43) Pub. Date: Mar. 21, 2024

(54) Goggles For Displaying Information

(71) Applicant: HEADS UP GOGGLES LLC, Middletown, DE (US)

(72) Inventor: Henry Stratford Pease, Cincinnati, OH (US)

(21) Appl. No.: 18/263,639

(22) PCT Filed: Jan. 31, 2022
(86) PCT No.: PCT/US2022/014530

§ 371 Date: Jul. 31, 2023

Related U.S. Application Data
(60) Provisional application No. 63/144,095, filed on Feb. 1, 2021.

(51) Int. Cl. G02B 27/01; G06F 3/01

(52) U.S. Cl. CPC G02B 27/0172; G02B 27/0101; G02B 27/0176; G02B 27/0179; G06F 3/011; G02B 2027/014; G02B 2027/0187

(57) ABSTRACT

The goggles (10) include a frame (12) and a spherical lens (36) coupled to the frame (12). The goggles (10) further include a display (62) coupled to the frame (12) and configured to show an image (98) thereon. The display (62) is spaced a distance (D) from an inner surface (46) of the spherical lens (36). The goggles (10) also include a control module (20) having a computing device (80), which is operatively coupled to the display (62) and configured to send a data set to the display (62) to form at least part of the image (98) on the display. When the distance (D) is less than the focal length (FL) of the spherical lens (36), the image (98) on the display (62) reflects off the spherical lens (36) so as to produce a virtual image (100) viewable by a wearer of the goggles (10).

### CROSS REFERENCE TO RELATED APPLICATION

This application claims the benefit of U.S. Provisional Patent Application Ser. No. 63/144,095, filed Feb. 1, 2021, the disclosure of which is incorporated by reference herein in its entirety.

### TECHNICAL FIELD

The invention relates generally to eyewear and, more particularly, to goggles for displaying information.

### BACKGROUND

Augmented Reality (AR) goggles, smart glasses, and head mounted displays are configured to display/project images, video, or information in front of a wearer's face so as to be viewable by the wearer's eyes. Typically, those goggles and glasses employ complicated optical components and methods to display images, video, or information. For example, the components may include lenses, prisms, mirrors, beam splitters, and (relatively expensive) waveguides. Each of these components takes space and adds cost, weight, and complexity.

What is needed, therefore, is an AR goggle that uses a minimal number of components to display images, video, or information.

### SUMMARY OF THE INVENTION

To these and other ends, one embodiment of the invention is goggles for displaying information, including real-time information. The goggles have a frame and a spherical exterior lens coupled to the frame. The spherical exterior lens has a radius of curvature RC and a focal length which is one-half the radius of curvature RC. The goggles further include a display coupled to the frame and configured to show an image thereon. The display is spaced a distance D from an inner surface of the spherical exterior lens. The goggles also include a control module having a computing device, such as a microcontroller. The computing device is operatively coupled to the display and configured to send a data set to the display to form at least part of the image on the display. When the distance D is less than the focal length of the spherical exterior lens, the image from the display reflects off the spherical exterior lens so as to produce a virtual image viewable by a wearer of the goggles. The spherical exterior lens may have a reflective coating covering at least a portion of an inner surface of the spherical exterior lens. The computing device may be configured to communicate wirelessly to a wirelessly-enable device, such as a smart phone. The data set to be projected on the image may include at least one of a compass direction, location information, a time, a speed, a temperature, and an altitude. The goggles may include an interior lens spaced apart from the spherical exterior lens to form an air gap between the interior lens and the spherical exterior lens.

In one aspect, the goggles may further include a compass module operatively coupled to the computing device and configured to provide a real-time compass direction to the computing device corresponding to a compass direction the goggles are facing. The real-time compass direction is included in the virtual image from the display. The real-time compass direction in the virtual image changes as the goggles face a different compass direction.

In another aspect, the goggles may include a long range radio operatively coupled to the computing device and a long range antenna coupled to the long range radio. The long range radio is configured to transmit and receive information to and from other goggles.

In one aspect, the radius of curvature RC of the spherical exterior lens is in the range of 7 cm to 14 cm and the distance D is in the range of 3 cm to 5 cm, and preferably the radius of curvature RC is 9 cm and the distance D is 3 cm.

Another embodiment of the invention contemplates a system for displaying real-time information. The system includes goggles, a frame, and a spherical exterior lens coupled to the frame. The spherical exterior lens has a radius of curvature RC and a focal length which is one-half the radius of curvature RC. The goggles further includes a display coupled to the frame and configured to show an image thereon. The display is spaced a distance D from an inner surface of the spherical exterior lens. The goggles also include a control module having a computing device, such as a microcontroller. The spherical exterior lens may have a reflective coating covering at least a portion of the inner surface of the spherical exterior lens. The computing device is operatively coupled to the display and configured to send a data set to the display to form at least part of the image on the display. When the distance D is less than the focal length of the spherical exterior lens, the image on the display reflects off the spherical exterior lens so as to produce a virtual image viewable by a wearer of the goggles. The system also includes a wirelessly-enabled device. The computing device is configured to communicate wirelessly with the wirelessly-enable device to receive real-time information from the wirelessly-enabled device and send that real-time information to the display as part of the data set. The data set to be projected on the image includes at least one of a compass direction, location information, a time, a speed, a temperature, and an altitude. The goggles may include an interior lens spaced apart from the spherical exterior lens to form an air gap between the interior lens and the spherical exterior lens.

In one aspect, the system further includes a compass module operatively coupled to the computing device and configured to provide a real-time compass direction to the computing device corresponding to a compass direction the goggles are facing. The real-time compass direction is included in the virtual image from the display. The real-time compass direction in the virtual image changes as the goggles face a different compass direction.

In another aspect, the system includes a long range radio operatively coupled to the computing device and a long range antenna coupled to the long range radio. The long range radio is configured to transmit and receive information to and from other goggles.

In one aspect, the radius of curvature RC of the spherical exterior lens is in the range of 7 cm to 14 cm and the distance D is in the range of 3 cm to 5 cm, and preferably the radius of curvature RC is 9 cm and the distance D is 3 cm.

### BRIEF DESCRIPTION OF THE DRAWINGS

The accompanying drawings, which are incorporated in and constitute a part of this specification, illustrate one or more embodiments of the invention, and together with a general description of the invention given above, and the detailed description given below, serve to explain the invention.

FIG. 1 is a perspective view of AR goggles according to an embodiment of the invention.

FIG. 2 is a cross-sectional view of the AR goggles taken along line 2-2 of FIG. 1.

FIG. 3 is a disassembled, perspective view of a display used in the AR goggles of FIG. 1.

FIG. 4 is an elevational view of a display assembly connected to a control module of the AR goggles of FIG. 1.

FIG. 5 is a top view of the AR goggles of FIG. 1.

FIG. 6 is an elevational view from the perspective of a wearer looking through the AR goggles of FIG. 1.

FIG. 7 is a schematic representation of an individual wearing the AR goggles of FIG. 1, which is wirelessly communicating with a smart device.

FIG. 8 is an exemplary representation of the screen of the smart device connected to the AR goggles of FIG. 1 displaying data received from the AR goggles.

### DETAILED DESCRIPTION OF THE INVENTION

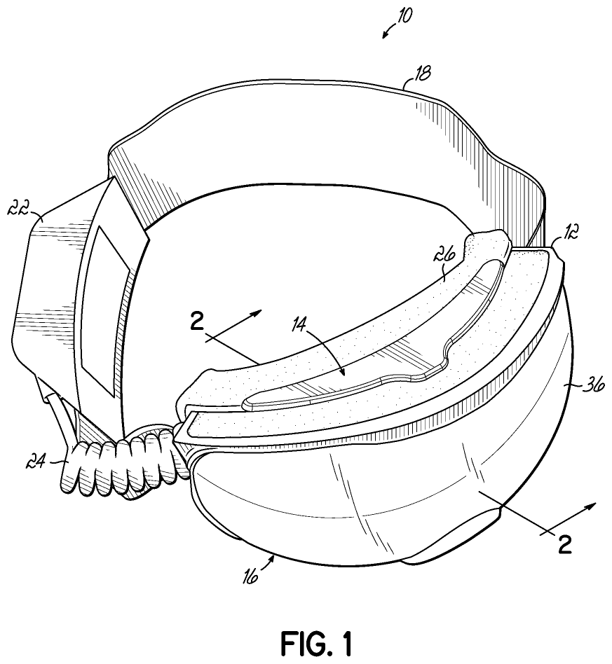

A pair of AR goggles 10 for displaying information, including real-time information, according to an embodiment of the invention is depicted in FIG. 1. The AR goggles 10 may be used in various activities such as skiing, off-road biking, paintball, scuba diving, etc. By way of example, but not limitation, this application will explain the AR goggles 10 in the context of snow skiing.

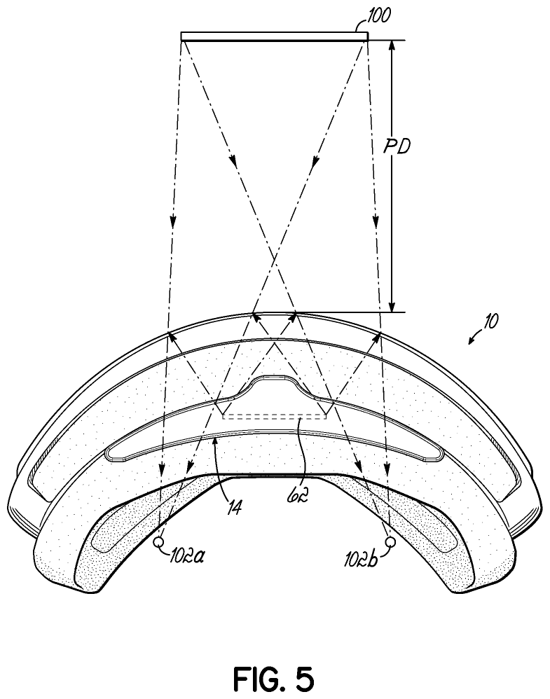

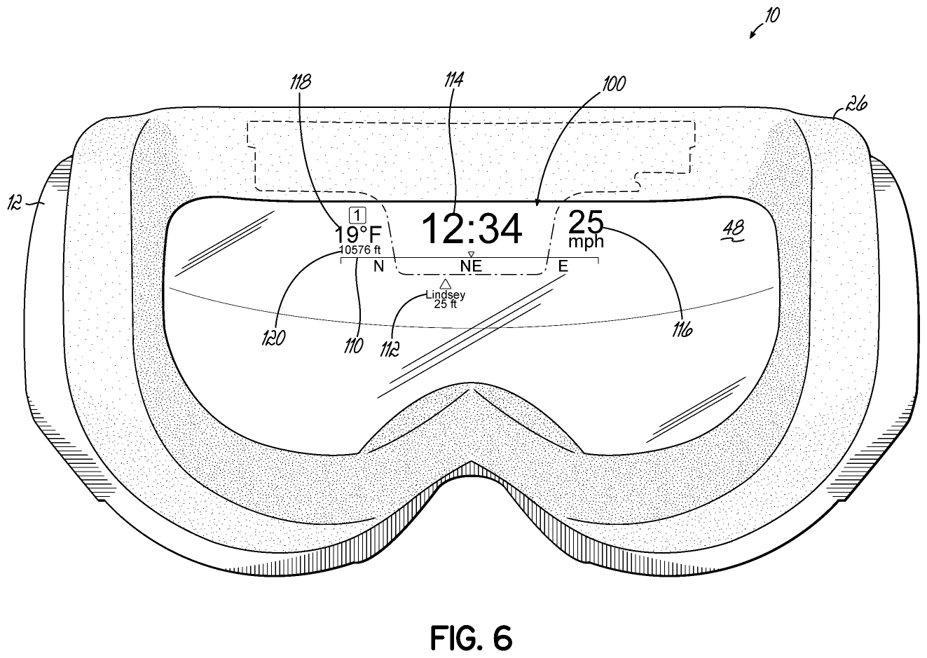

The AR goggles 10 includes a frame 12, a display assembly 14 (FIG. 5) operatively coupled to the frame 12, a lens assembly 16 operatively coupled to the frame 12, and strap 18 incorporating a control module 20 (FIG. 6) in a housing 22. The display assembly 14 is connected to the control module 20 via a flexible cable 24 configured to transmit data between the display assembly 14 and the control module 20. A sealing member 26 surrounds a periphery of the frame 12. The sealing member 26 may be made of any suitable material for forming a seal with a wearer's face. The sealing member 26 may be formed from foam, rubber, or the like.

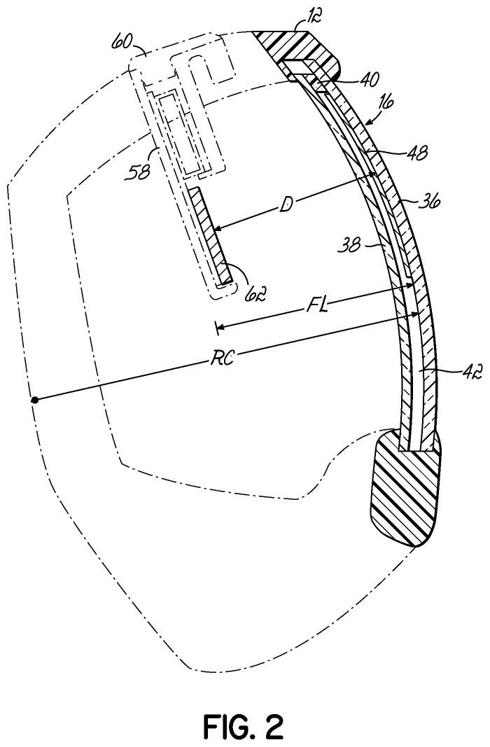

Referring to FIG. 2, the lens assembly 16 includes an exterior lens 36 and an interior lens 38 separated by a spacer 40, which extends around the periphery of the exterior lens 36 and the interior lens 38 to create an air gap 42 between the exterior lens 36 and the interior lens 38. The air gap 42 helps to minimize fogging of the lens assembly 16 when the AR goggles 10 are used in a cold environment such as while snow skiing. In an embodiment, the exterior lens 36 and the interior lens 38 may have a spherical shape, with a radius of curvature RC in the range of 7 cm to 14 cm (2.76 in. to 5.51 in.) and preferably about 9 cm (3.54 in.). The exterior lens 36 includes an outer surface 44 and an inner surface 46. In an embodiment, the inner surface 46 may include a reflective mirror coating 48 that covers at least a portion of the inner surface 46 of the exterior lens 36. For example, the reflective mirror coating 48 may extend from the top of the exterior lens 36 to approximately half way down the exterior lens 36. With the reflective mirror coating 48, the exterior lens 36 behaves like a concave mirror as will be discussed in greater detail below. The exterior lens 36 and the interior lens 38 may be coated with an anti-smudge coating to enhance visibility.

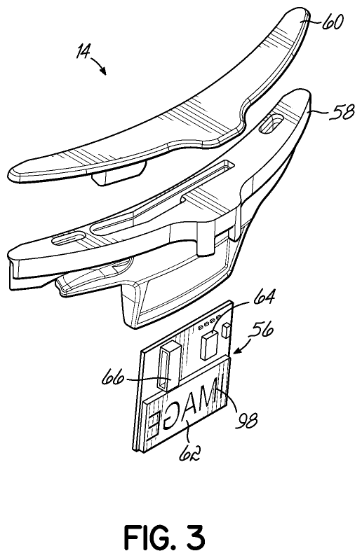

Referring to FIG. 3, the display assembly 14 includes a circuit board 56, a holder 58, and a cap member 60. The circuit board 56 includes a display 62, a compass module 64, and a multi-pin connector 66. In an embodiment, the compass module 64 may include an accelerometer, a gyroscope, or other sensors to track the movement of the wearer's head. When assembled, the circuit board 56 is affixed to the holder 58 and the cap member 60 is removably attached to the top of the holder 58. In one embodiment, the display 62 may be a monochromatic LED with a resolution of 128×64. Other displays may be used with full color and higher resolutions.

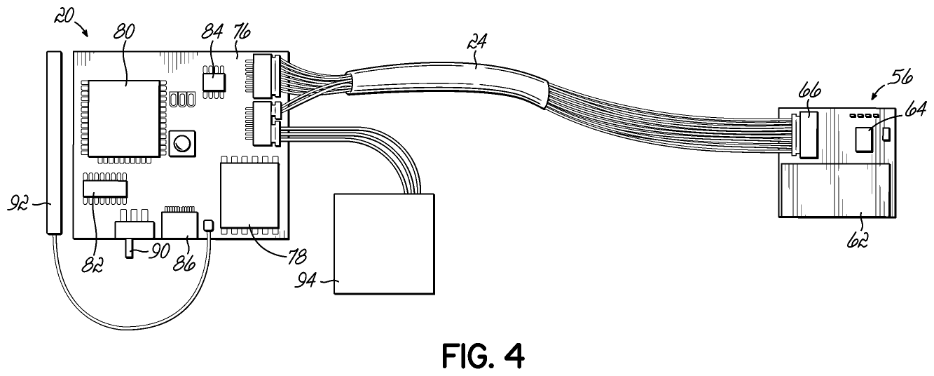

As depicted in FIG. 4, the display assembly 14 is connected to the control module 20 with the cable 24. The control module 20 includes a circuit board 76, which includes a long range radio 78, a computing device 80 such as a microcontroller, a USB transceiver 82, a battery charger 84, a USB charging port 86, a reset button 88, and an on/off switch 90. A long range antenna 92 is connected to the circuit board 76. A battery 94 is connected to the circuit board 76 to power the circuit board 76 and the display assembly 14. The control module 20, the long range antenna 92, and the battery 94 are intended to be contained within housing 22. The long range antenna 92 may operate at 915 MHz, 868 MHz, 433 MHz, or whatever ISM frequency bands are allowed where the device is in use. The computing device 80 may be configured to communicate wirelessly, such as via Bluetooth™, with a wirelessly-enabled device, such as a smart phone. As depicted in FIG. 4, there are two separate circuit boards 56, 76. In an embodiment, the two circuit boards 56, 76 may be combined into a single circuit board contained in the holder 58. In such an embodiment, the housing 22 would primarily hold just the battery 94. In a similar embodiment, the two combined circuit boards 56, 76 and the battery 94 may be contained within the holder 58 and therefore the housing 22 may be eliminated.

The display 62 is spaced a distance D from the inner surface 46 of the exterior lens 36 as depicted in FIG. 2. As noted above, the exterior lens 36 with the reflective mirror coating 48 acts like a concave mirror. The exterior lens 36 has a focal length FL (FIG. 2), which is half the radius of curvature RC. The distance D is preferably less than or equal to the focal length FL. However, if the distance D is too short, the image from the display 62 will not be magnified very much. In an embodiment the distance D may be in the range of 3 cm to 5 cm (1.18 in. to 1.97 in.) and preferably the distance D is 3 cm (1.18 in.).

The display 62 is configured to show an image 98 thereon. The image 98 on the display 62 is “backward” as if looking at the image 98 in a mirror. When the image 98 on the display 62 reflects off the exterior lens 36, the image 98 is flipped so it is seen as “correct” by a wearer of the AR goggles 10. In other words, the shape of the spherical lens causes the reflection off the spherical lens to flip the “backward” image 98 on the display so that the image 98 appears correct to the wearer of the AR goggles 10. The reflective mirror coating 48 on the inner surface 46 of the exterior lens 36 increases the brightness of the virtual image 100. When the distance D is less than or equal to the focal length FL, the image 98 of the display 62 reflects off the exterior lens 36 so as to produce a virtual image 100 as depicted in FIG. 5 viewable by the wearer of the AR goggles 10. More specifically, the virtual image 100 is perceived by the wearer of the AR goggles 10 as being positioned in front of the exterior lens 36 by a projected distance PD. The approximate location of the wearer's eyes 102a, 102b are depicted by unfilled circles in FIG. 5. The distance D and shape of the spherical lens 36 sets the projected distance PD, which affects the focus, magnification, and perceived parallax of the virtual image 100 as depicted in FIG. 5. By virtue of being reflected off the spherical lens 36, which behaves essentially as a concave mirror, the image 98 is focused farther away and magnified to form the virtual image 100. Each eye 102a, 102b sees the reflection of the image 98 from a part of the spherical lens 36 that slants back towards the image 98, which reduces parallax by putting the virtual image 100 closer to the center of each eye's 102a, 102b field of view, resulting in an increased projected distance PD. If the distance D is too short, i.e., too close to the exterior lens 36, the wearer may experience too much parallax such that the wearer must cross his or her eyes to see the virtual image 100, the overall image size may be too small, i.e., not sufficiently magnified, and the virtual image 100 may be focused too close to the wearer causing eye strain and appearing blurry if the wearer has normal vision, i.e., not significantly nearsighted. If the distance D equals the focal length, the virtual image 100 would be focused at infinity. If the distance D is greater than the focal length, the virtual image 100 would be flipped upside down. In the end, the radius of curvature RC of the exterior lens 36 and the distance D should be wisely selected to yield the virtual image 100 that is properly magnified, in focus, and readable without excessive parallax or distortion and not focused too near the wearer's eyes.

In use, the computing device 80 transmits a data set comprising a variety of information to form at least part of the image 98 on the display 62, which the wearer sees in the virtual image 100. An exemplary virtual image 100 is depicted in FIG. 6. In an embodiment, the virtual image 100 will appear in the center and just above the wearer's line of sight. The virtual image 100 may contain a variety of information, including real-time information, such as a compass direction 110, location information 112 (e.g., name, relative distance, and compass direction) of other individuals in the wearer's group, time 114, wearer's speed 116, temperature 118, and elevation 120 (altitude), for example. Other data may be displayed as well as information including, but not limited to, text messages, music, ski trail recognition, estimated lift line wait times, and points of interest depending on the type of activity. The compass direction 110 updates in real-time as the wearer turns his or her head and the AR goggles 10 face a different direction. Similarly, the location information 112 (name, relative distance, and compass direction) from other connected individuals changes in real-time as the wearer moves (e.g., skis) or as the other connected individuals move. The virtual image 100 may display the location information 112 for more than one connected individual. For example, if the group has four connected individuals plus the wearer, the virtual image 100 may separately display the location information 112 for those four connected individuals. The compass direction and location data may come from the compass module 64 and a GPS sensor on the control module 20 or from GPS information from the wearer's wirelessly-connected device, such as a smart phone. The long range radio 78 may connect with other connected individuals wearing the AR goggles 10 so that the location information 112 of the other connected individuals may be transmitted to the control module 20 of the wearer.

With the sharing of location information 112, the AR goggles 10 may serve an important safety role. For example, the AR goggles 10 may detect falls and alert other connected individuals. The AR goggles 10 may also detect when one of the connected individuals has become separated from the other connected individuals or has entered a dangerous area. This detection feature may be valuable to families with young skiers or to ski school groups (instructors with students). The AR goggles 10 may also allow the wearer to set static pings or waypoints to mark a location for the group (e.g., can mark dangerous conditions, a meeting spot, etc.).

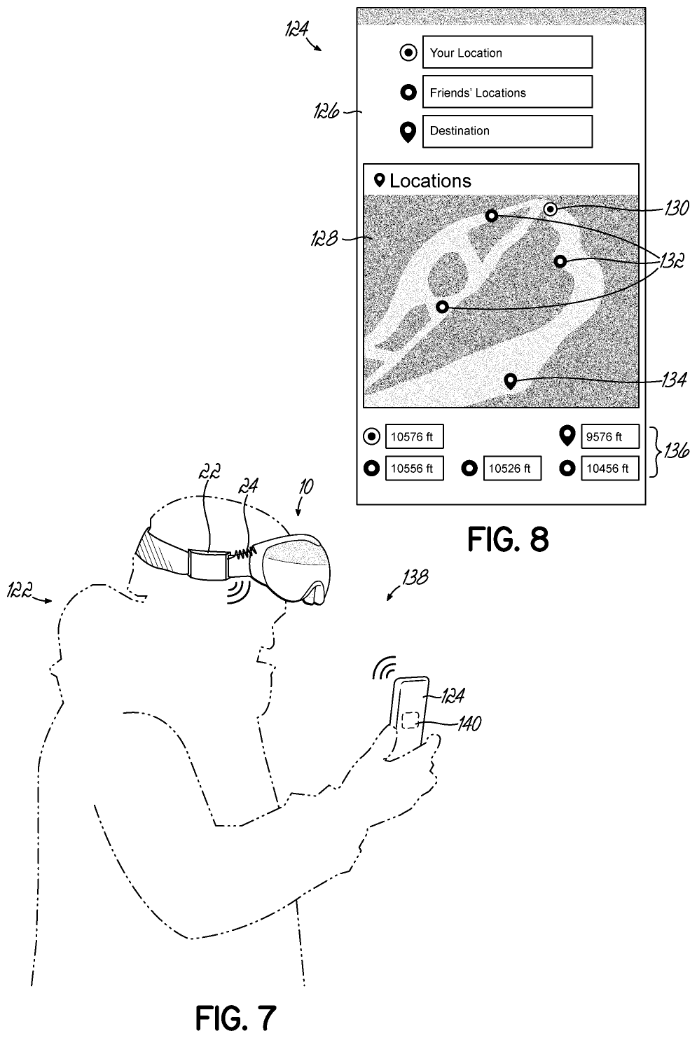

FIG. 7 depicts an individual 122 wearing the AR goggles 10 and holding a wirelessly-connected device 124, such as a smart phone, with a GPS module 140. The AR goggles 10 and the wirelessly-connected device 124 may be considered a system 138 for displaying real-time information according to one embodiment of the invention. The wirelessly-connected device 124 may run an application that displays on its screen 126 some or all the information (e.g., speed, altitude, time, notifications, etc.) that is seen in the virtual image 100 by the individual wearing the AR goggles 10. The application also allows users to join a group to monitor the real time location of every member that is part of the group. Each user's location may be obtained using the GPS information (e.g., speed, altitude, and time) from the GPS module 140 in his or her smart phone 124 and transmitted to the entire group via a remote internet server. The application allows users in the group to monitor the location of others in the group even if that particular user is not wearing the AR goggles 10. For example, a user in the group may monitor the location of others in the group when that user is in a cabin or ski lodge. The FIG. 8 displays an exemplary screenshot of the screen 126 of the wirelessly-connected device 124 running the application. In this particular screenshot, the screen 126 displays a map 128 of the ski trails in a ski resort. Overlayed on the map 128 is the individual's current position 130, positions of other connected individuals 132, and the desired destination 134. The elevation (altitude) 136 of the various individuals and the desired location is also shown on the screen 126.

To ensure the wearer remains connected to the group in areas with potentially bad cellular reception, the AR goggles may use a fusion of cellular data from the wearer's cellphone and data from a long range (LoRa) radio mounted on the second PCB. In areas with no or limited cell reception, the AR goggles may still indicate the up to date locations of other members in the group with the AR goggles 10 by transmitting locations directly over the LoRa radio.

The AR goggles 10 may include additional sensors to provide additional functionality and usefulness depending on the activity. For example, the AR goggles 10 may include a laser rangefinder to enable the wearer to ping or set waypoints directly through the AR goggles 10 to places a specific distance and direction away from a wearer's current location. In addition, the AR goggles 10 may include multiple cameras on the front, sides, and rear of the AR goggles 10. The view from one or more of the multiple cameras may be displayed in the virtual image 100. The video from the cameras may also be recorded. The AR goggles 10 may be used to view and control the status of the cameras, for example by viewing a preview of the recording, whether the camera is currently recording, and the remaining battery charge of the camera.

While the invention has been illustrated by a description of various embodiments, and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

What is claimed is:

1. Goggles for displaying information comprising:
a frame;
a spherical exterior lens coupled to the frame, the spherical exterior lens having a radius of curvature RC and a focal length which is one-half the radius of curvature RC;
a display coupled to the frame and configured to show an image thereon, the display being spaced a distance D from an inner surface of the spherical exterior lens; and
a control module having a computing device, the computing device operatively coupled to the display and configured to send a data set to the display to form at least part of the image on the display,
wherein when the distance D is less than or equal to the focal length of the spherical exterior lens, the image on the display reflects off the spherical exterior lens so as to produce a virtual image viewable by a wearer of the goggles.

2. The goggles of claim 1, wherein the spherical exterior lens has a reflective coating covering at least a portion of the inner surface of the spherical exterior lens.

3. The goggles of claim 1 further comprising:
a compass module operatively coupled to the computing device and configured to provide a real-time compass direction to the computing device corresponding to a compass direction the goggles are facing,
wherein the real-time compass direction is included in the virtual image from the display and wherein the real-time compass direction in the virtual image changes as the goggles face a different compass direction.

4. The goggles of claim 1 further comprising:
a long range radio operatively coupled to the computing device; and
a long range antenna coupled to the long range radio,
wherein the long range radio is configured to transmit and receive information to and from other goggles.

5. The goggles of claim 1, wherein the radius of curvature RC of the spherical exterior lens is in the range of 7 cm to 14 cm and the distance D is in the range of 3 cm to 5 cm.

6. The goggles of claim 5, wherein the radius of curvature RC is 9 cm and the distance D is 3 cm.

7. The goggles of claim 1, further comprising an interior lens spaced apart from the spherical exterior lens to form an air gap between the interior lens and the spherical exterior lens.

8. The goggles of claim 1, wherein the computing device is configured to communicate wirelessly to a wirelessly-enable device.

9. The goggles of claim 1, wherein the data set to be projected on the image includes at least one of a compass direction, location information, a time, a speed, a temperature, and an altitude.

10. The goggles of claim 1, wherein the computing device is a microcontroller.

11. A system for displaying information comprising:
goggles including:
a frame;
a spherical exterior lens coupled to the frame, the spherical exterior lens having a radius of curvature RC and a focal length which is one-half the radius of curvature RC;
a display coupled to the frame and configured to show an image thereon, the display being spaced a distance D from an inner surface of the spherical exterior lens; and
a control module having a computing device, the computing device operatively coupled to the display and configured to send a data set to the display to form at least part of the image on the display,
wherein when the distance D is less than the focal length of the spherical exterior lens, the image on the display reflects off the spherical exterior lens so as to produce a virtual image viewable by a wearer of the goggles; and
a wirelessly-enabled device,
wherein the computing device is configured to communicate wirelessly with the wirelessly-enable device to receive real-time information from the wirelessly-enabled device and send that real-time information to the display as part of the data set.

12. The system of claim 11, wherein the spherical exterior lens has a reflective coating covering at least a portion of the inner surface of the spherical exterior lens.

13. The system of claim 11 further comprising:
a compass module operatively coupled to the computing device and configured to provide a real-time compass direction to the computing device corresponding to a compass direction the goggles are facing,
wherein the real-time compass direction is included in the virtual image from the display and wherein the real-time compass direction in the virtual image changes as the goggles face a different compass direction.

14. The system of claim 11 further comprising:
a long range radio operatively coupled to the computing device; and
a long range antenna coupled to the long range radio,
wherein the long range radio is configured to transmit and receive information to and from other goggles.

15. The system of claim 11, wherein the radius of curvature RC of the spherical exterior lens is in the range of 7 cm to 14 cm and the distance D is in the range of 3 cm to 5 cm.

16. The system of claim 15, wherein the radius of curvature RC is 9 cm and the distance D is 3 cm.

17. The system of claim 11, further comprising an interior lens spaced apart from the spherical exterior lens to form an air gap between the interior lens and the spherical exterior lens.

18. The system of claim 11, wherein the data set to be shown by the image includes at least one of a compass direction, location information, a time, a speed, a temperature, and an altitude.

19. The system of claim 11, wherein the computing device is a microcontroller.
